(19) United States
(12) Patent Application Publication
(10) Pub. No.: US 2006/0280324 A1
(43) Pub. Date: Dec. 14, 2006

(54) Interface facility for signal transmission between a hearing aid device and an external device

(76) Inventors: Frank Beck, Spardorf (DE); Esfandiar Grafenberg, Effeltrich (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/416,482

(22) Filed: May 2, 2006

(30) Foreign Application Priority Data
May 2, 2005 (DE) 10 2005 020 322.1

(51) Int. Cl. H04R 25/00

(52) U.S. Cl. 381/312; 381/323

(57) ABSTRACT

The signal transmission between a hearing aid device and an external device is to be improved. For this purpose, a first signal transmission facility arranged on or in the hearing aid device and a second signal transmission facility which can be connected in a mechanically detachable manner to the hearing aid device is proposed, with an optical signal transmission taking place between the first signal transmission facility and the second signal transmission facility. The electrical contacts used to date can hereby be avoided.

### CROSS REFERENCE TO RELATED APPLICATIONS

This application claims priority of German application No. 102005020322.1 filed May 2, 2005, which is incorporated by reference herein in its entirety.

### FIELD OF THE INVENTION

The invention relates to an interface facility for signal transmission between a hearing aid device and an external device, comprising a first signal transmission facility arranged on or in the hearing aid device and a second signal transmission facility which can be connected in a mechanically detachable manner to the hearing aid device.

### BACKGROUND OF THE INVENTION

Various signal transmission types are known for the purpose of signal transmission between a hearing aid device and an external device. By way of example, hearing aid devices frequently comprise a programming socket, by means of which the hearing aid device can be connected to a programming device via a cable and a plug connector connected thereto.

An audio shoe for connection to a hearing aid device is known from DE 298 19 993 U1, by means of which audio signals emitted by an audio device can be transmitted to the hearing aid device via a cable. Both the hearing aid device and also the audio shoe feature electrical contacts for signal transmission between the audio shoe and the hearing aid device.

Besides a cable link between a hearing aid device and an external device, a wireless signal transmission between the devices is also known. U.S. Pat. No. 4,947,432 describes a programming device with a transmitting device and a hearing aid device with a receiving device for wireless signal transmission between the programming device and the hearing aid device. The wireless signal is transmitted here by ultrasound signals, infrared signals or electromagnetic signals. Distances ranging from a few meters up to a few hundred meters can be bridged wirelessly.

WO 01/39569 A2 discloses a method for signal transmission between a hearing aid device and an external device, in which a cable in a magnetic holder connected to the device discharges in order to fasten magnetically to the hearing aid device. The signal transmission between the magnetic holder and the hearing aid device is undertaken in an inductive or capacitative manner.

Technically speaking, the known methods for wireless signal transmission between a hearing aid device and an external device are relatively costly, error-prone and significantly limited in terms of the achievable data transmission rates.

A cable link with electrical contacts on the interface between the hearing aid device and the cable is disadvantageous in that the manual attachment of a plug connector, in the form of an audio shoe for instance, to the electrical contacts of the hearing aid device is often difficult, whereby older people in particular have difficulties as a result of restricted tactile sensory analysis and reduced manual capabilities. Furthermore, electrical contacts tend to become corroded and/or contaminated, thereby rendering the link unreliable. This can cause interference to occur during audio transmission.

Hearing aid spectacles with a first and a second hearing aid device for the binaural coverage of a user is known from DE 197 04 119 C1, in which signals are transmitted optically from the first hearing aid device to the second hearing aid device via the bridge of the spectacles.

A hearing aid device with an audio and/or programming terminal is known from DE 298 19 993 U1. The signals are transmitted between the hearing aid device and the audio and/or programming terminal by means of mechanical contacts.

DE 38 34 962 A1 discloses a programming device for a hearing aid which is equipped with a standard interface for linking with a personal computer or a printer. The interface contains optocouplers so that the safety conditions for medical devices can also be satisfied when conventional personal computers are connected.

### SUMMARY OF THE INVENTION

The object of the present invention is to create an interface for signal transmission between a hearing aid device and an external device, which is cost-effective and simple to operate and moreover allows relatively high data transmission rates.

This object is achieved by an interface facility for signal transmission between a hearing aid device and an external device, comprising a first signal transmission facility arranged on or in the hearing aid device and a second signal transmission facility which can be connected in a mechanically detachable manner to the hearing aid device, with means for optical signal transmission being available between the first and the second signal transmission facility.

The invention differs in that the signal transmission is carried out on the interface between the hearing aid device and the second signal transmission facility which can be fastened to the hearing aid device using optical means. The optical transmitting and receiving devices used for this purpose, in particular light-emitting diodes and receiving diodes, are not sensitive to external influences, cost-effective, easy to adjust and moreover stand out due to a low power feed required for the signal transmission. High signal transmission rates are thus achieved by there being a very short distance between the means for optical signal transmission when in use and by these means being additionally aligned optimally to one another.

Both the signal transmission facility on the hearing aid device and also the second signal transmission facility which can be connected thereto can feature a smooth surface which is easy to look after. A secure signal transmission is generally also ensured if the first and the second signal transmission facility are not aligned exactly to one another. This facilitates the setting up of the link between the hearing aid device and the external device, particularly with older users. Furthermore, the optical signal transmission is, as far as possible, not sensitive to interference signals, for example electromagnetic interference signals which are emitted by mobile telephones and the like.

The signals which can be transmitted by means of the invention can be control signals, data signals, audio signals etc. The signals can be present in analog or digital form. When low signal transmission rates are required, a serial signal transmission is generally adequate. When higher signal transmission rates are required, for transmitting digital audio signals for instance, the signal transmission is carried out by means of the interface facility, preferably in parallel form. For this purpose, the first and also the second signal transmission facility feature a number of transmitting and receiving devices arranged in parallel.

The signal transmission between the hearing aid device and the external device is usually carried out starting from the external device to the hearing aid device. It is however entirely possible for the signal to be transmitted in the opposite direction. By way of example, data can be read out from the hearing aid device during the programming. In this case, transmitting and receiving devices are both to be provided with the first and the second signal transmission facility.

With a particular embodiment of the invention, the second signal transmission facility comprises means for wireless signal transmission between the external device and the signal transmission facility. The second signal transmission facility is equipped with a Bluetooth transceiver for example. The signals transmitted wirelessly in this manner between the external device and the second signal transmission facility are then transferred according to the invention between the second signal transmission facility and the hearing aid device using optical means. A Bluetooth transceiver is thus not needed in the hearing aid device itself but only in the second signal transmission facility. This allows the hearing aid device to be designed more compactly.

### BRIEF DESCRIPTION OF THE DRAWINGS

The invention is described in more detail below with reference to exemplary embodiments, in which;

FIG. 1 shows one end of a hearing aid device which can be worn behind the ear and an audio shoe which can be connected mechanically thereto and

FIG. 2 shows a part of a hearing aid device which can be worn behind the ear and a signal transmission facility which can be fastened thereto by means of a magnetic holder.

### DETAILED DESCRIPTION OF THE INVENTION

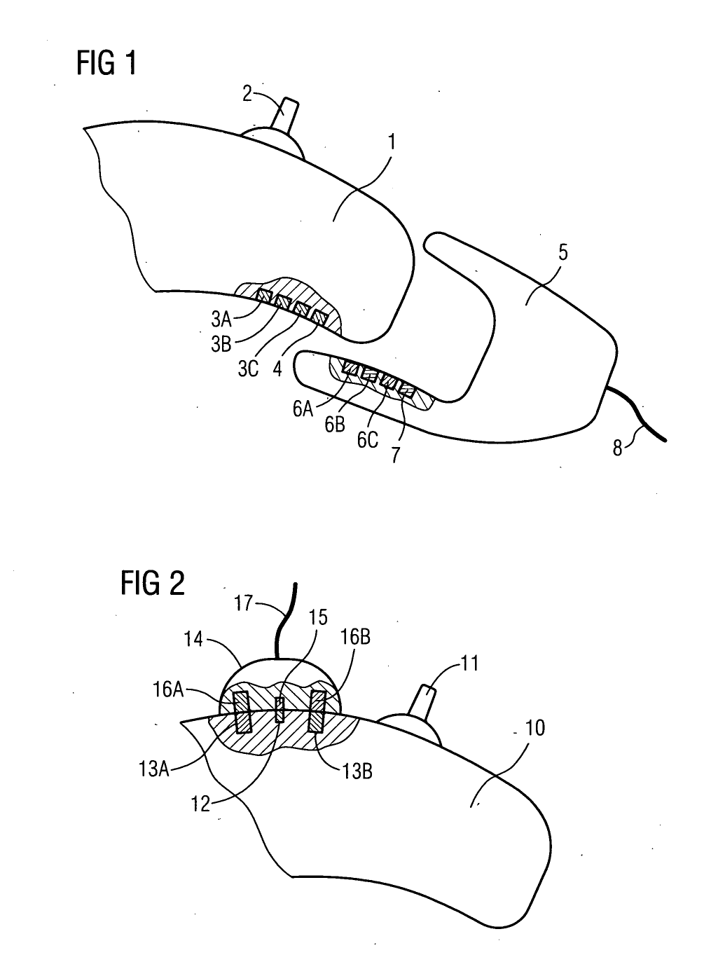

FIG. 1 shows one end of a hearing aid device 1 which can be worn behind the ear. This is equipped with a switch 2, by means of which the hearing aid device can be switched on or off for instance. The hearing aid device 1 further comprises a signal transmission facility for the signal transmission between the hearing aid device 1 and an external device. The signal transmission facility of the hearing aid device comprises three optical receive diodes 3A to 3C, by means of which a parallel optical signal transmission to the hearing aid device is enabled. A light-emitting diode 4 is further present, which also allows a signal transmission from the hearing aid device 1 to an external device. The transmitting and/or receiving diodes are integrated into the hearing aid device 1 such that a smoother course of the hearing aid device housing is also provided in the region of the diodes. To this end, light-permeable segments are integrated for instance into the housing.

FIG. 1 further shows a second signal transmission facility in the form of an audio shoe 5, which can be fixed to the hearing aid device 1 in a mechanically detachable manner. By way of example, the audio shoe 5 can be connected in a friction-resistant manner to the housing of the hearing aid device 1. Similar to the hearing aid device 1, the audio shoe 5 also comprises means for optical signal transmission between the audio shoe and the hearing aid device 1, in particular 3 light-emitting diodes 6A to 6C for transmitting optical signals as well as an optical receiving diode 7. With an audio shoe 5 attached to the hearing aid device 1, the diodes 3A to 3C and 4 of the hearing aid device 1 and/or 6A to 6C and 7 of the audio shoe 5 are at least approximately arranged opposite to one another. With the arrangement depicted, a parallel optical signal transmission from the audio shoe 5 to the hearing aid device 1 as well as a serial signal transmission from the hearing aid device 1 to the audio shoe 5 can thus take place. In the exemplary embodiment, the signal transmission between the audio shoe 5 and the external device is carried out in a wired manner via the cable 8. It is nevertheless also possible for the audio shoe 5 to comprise a transmitting and receiving device for wireless electromagnetic signal transmission between the audio shoe and the external device (not shown).

FIG. 2 shows a further exemplary embodiment of the invention, in which one end of a hearing aid device 10 which can be worn behind the ear is also shown. This also comprises a switch 11, e.g. for switching the hearing aid device 10 on or off. Furthermore, the exemplary embodiment shows a very simple and cost-effectively structured interface facility with an optical receiving diode 12 which is arranged in the hearing aid device 10. This is integrated into the hearing aid device 10 such that a smooth profile of the hearing device housing is provided. Furthermore, the interface facility comprises a signal transmission facility 14 with a light-emitting diode 15 which can be connected in a detachable manner to the hearing aid device 10. Magnetic or magnetizable elements 13A and 13B are present on the hearing aid device 10 for the detachable link of the signal transmission facility 14 at the housing of the hearing aid device 10. The signal transmission facility 14 likewise also comprises magnetic or magnetizable elements 16A and 16B, which are configured such that a magnetic holder and fixing of the signal transmission facility 14 is carried out on the hearing aid device 10. The signal transmission facility 14 can be fastened to or detached from the hearing aid device 10 in a simple manner. Once the interface facility 14 is located directly adjacent to the hearing aid device 10, it is magnetically attracted, with the light-emitting diode 15 and the receiving diode 12 automatically adjusting the magnetic or magnetizable elements 13A, 13B, 16A and 16B in the event of a clever selection and arrangement. A signal line 17 is available for the signal transmission between the signal transmission facility 14 and the external device. This is connected to the light-emitting diode 15. If, conversely, this signal line 17 is an optical line, this is preferably carried out by the signal transmission facility 14 and thus supersedes the light-emitting diode 15. The end of the optical line operates in this case as an optical transmitter. The exemplary embodiment thus indicates a very simply designed and easy to operate interface facility, which additionally ensures a high signal transmission rate with minimal interference.

1-7. (canceled)

8. An interface facility for signal transmission between a hearing aid device and an external electronic device, comprising:
a first signal transmission facility arranged on the hearing aid device; and
a second signal transmission facility detachably connectable to the hearing aid device,
wherein an optical signal is transmitted between the first and the second signal transmission facility,
wherein a signal is transmitted between the second signal transmission facility and the external electronic device.

9. The interface facility as claimed in claim 8, wherein the signal transmitted between the second signal transmission facility and the external electronic device is an electrical signal via a wired connection.

10. The interface facility as claimed in claim 8, wherein the signal transmitted between the second signal transmission facility and the external electronic device is an electromagnetic signal via a wireless connection.

11. The interface facility as claimed in claim 8, wherein the second signal transmission facility comprises an optical transmitting device.

12. The interface facility as claimed in claim 11, wherein the optical transmitting device is a light-emitting diode.

13. The interface facility as claimed in claim 8, wherein the second signal transmission facility comprises an optical receiving device.

14. The interface facility as claimed in claim 13, wherein the optical receiving device is a receiving diode.

15. The interface facility as claimed in claim 8, wherein the first signal transmission facility comprises an optical transmitting device.

16. The interface facility as claimed in claim 15, wherein the optical transmitting device is a light-emitting diode.

17. The interface facility as claimed in claim 8, wherein the first signal transmission facility comprises an optical receiving device.

18. The interface facility as claimed in claim 17, wherein the optical receiving device is a receiving diode.

19. The interface facility as claimed in claim 8, wherein the interface facility transmits serial signals.

20. The interface facility as claimed in claim 8, wherein the interface facility transmits parallel signals.

21. The interface facility as claimed in claim 8, wherein the second signal transmission facility is detachably connectable to the hearing aid device by a mechanical friction resistant device.

22. The interface facility as claimed in claim 8, wherein the second signal transmission facility is detachably connectable to the hearing aid device by a magnetic holder.

23. The interface facility as claimed in claim 8, wherein the second signal transmission facility is an audio shoe.

24. The interface facility as claimed in claim 8, wherein the first signal transmission facility is integrated into the hearing aid device.

25. A hearing aid device with an interface for transmitting a signal between the hearing aid device and an external electronic device, comprising:
a first signal transmission facility arranged on the hearing aid device; and
a second signal transmission facility detachably connectable to the hearing aid device, wherein an optical signal is transmitted between the first and the second signal transmission facility,
wherein a signal is transmitted between the second signal transmission facility and the external electronic device.

26. The hearing aid device as claimed in claim 25, wherein the signal transmitted between the second signal transmission facility and the external electronic device is an electrical signal via a wired connection.

27. The hearing aid device as claimed in claim 25, wherein the signal transmitted between the second signal transmission facility and the external electronic device is an electromagnetic signal via a wireless connection.
